(19) United States
(12) Patent Application Publication
(10) Pub. No.: US 2015/0356529 A1
(43) Pub. Date: Dec. 10, 2015

(54) Digital Purchase Transfers Between Separate Retailers

(71) Applicant: Disney Enterprises, Inc., Burbank, CA (US)

(72) Inventors: Edward C. Drake, Stevenson Ranch, CA (US); Jeffrey A. Steele, Los Angeles, CA (US)

(73) Assignee: DISNEY ENTERPRISES, INC.

(21) Appl. No.: 14/301,237

(22) Filed: Jun. 10, 2014

(51) Int. Cl. G06Q 20/12

(52) U.S. Cl. CPC G06Q 20/123

(57) ABSTRACT

There are provided systems and methods for digital purchase transfers between separate retailers. One method includes retrieving a receipt for the media content purchased from a first retailer, transmitting the receipt to a redemption server, receiving a token from the redemption server in response to the transmitting of the receipt to the redemption server, transmitting the token to the second retailer, and receiving the media content from the second retailer in response to the transmitting of the token to the second retailer.

### BACKGROUND

When a consumer purchases a movie from a first retailer, it is desirable for the consumer to be able to redeem that purchase from other retailers. For example, if a consumer purchases a movie from a first retailer, the consumer may be able to stream or download the movie to his or her device from the first retailer. However, if the first retailer closes the streaming and downloading service, such as by going out of business, the consumer may no longer be able to stream the movie from the first retailer. In such a situation, it would be desirable for the consumer to be able to stream the movie from a second retailer that also provides the movie. Today, this can be quite difficult for the consumer, since the first retailer and the second retailer do not interact with each other, such that the second retailer may not know about the consumer's purchase of the movie from the first retailer.

### SUMMARY

The present disclosure is directed to digital purchase transfers between separate retailers substantially as shown in and/or described in connection with at least one of the figures, as set forth more completely in the claims.

### BRIEF DESCRIPTION OF THE DRAWINGS

FIG. 1 presents a system for digital purchase transfers between separate retailers, according to one implementation of the present disclosure.

FIG. 2 presents a user device used in digital purchase transfers between separate retailers, according to one implementation of the present disclosure.

FIG. 3 presents a redemption server used in digital purchase transfers between separate retailers, according to one implementation of the present disclosure.

FIG. 4 shows a flowchart illustrating a method for a user device performing digital purchase transfers between separate retailers, according to one implementation of the present disclosure.

FIG. 5 shows a flowchart illustrating a method for a redemption server performing digital purchase transfers between separate retailers, according to one implementation of the present disclosure.

### DETAILED DESCRIPTION

The following description contains specific information pertaining to implementations in the present disclosure. The drawings in the present application and their accompanying detailed description are directed to merely exemplary implementations. Unless noted otherwise, like or corresponding elements among the figures may be indicated by like or corresponding reference numerals. Moreover, the drawings and illustrations in the present application are generally not to scale, and are not intended to correspond to actual relative dimensions.

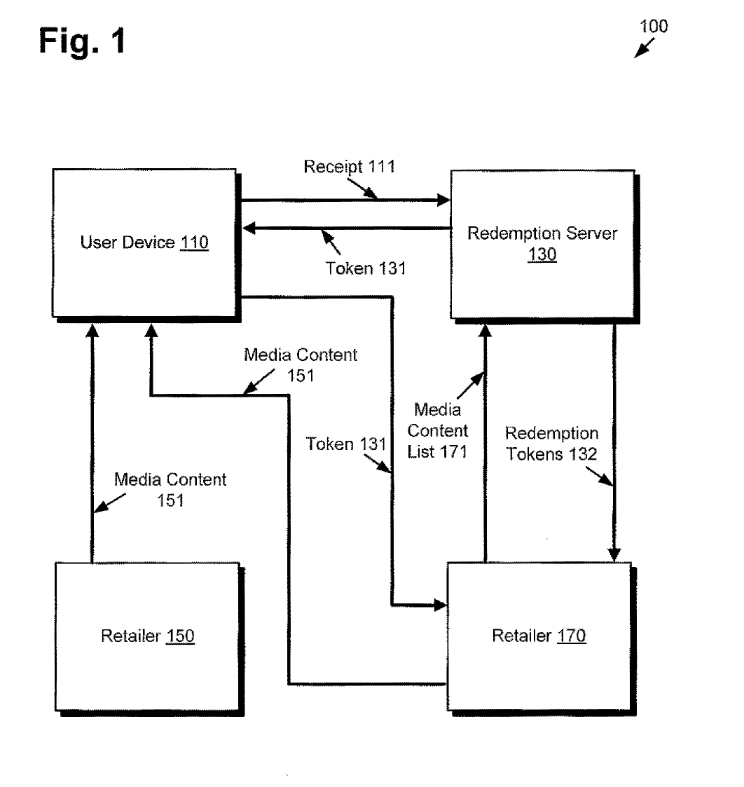

FIG. 1 presents a system for digital purchase transfers between separate retailers, according to one implementation of the present disclosure. System 100 of FIG. 1 includes user device 110, redemption server 130, retailer 150, and retailer 170. System 100 further includes receipt 111, token 131, redemption tokens 132, media content 151, and media content list 171.

As illustrated in FIG. 1, system 100 includes user device 110, redemption server 130, retailer 150, and retailer 170. User device 110 may include a personal computer, a mobile phone, a tablet, or any other device capable of executing a redemption software application to receive media content from media retailers. Redemption server 130 may include a cloud based server, personal computer, or any other device capable of receiving receipts from user devices and transmitting tokens to the user devices in response to receiving the receipts. Finally, retailer 150 and retailer 170 may each include a server, a webpage, a vendor, a retail store, or any other device or entity that distributes media content to user devices.

Also illustrated in FIG. 1, user device 110 receives media content 151 from retailer 150. Media content 151 may include a creative media work or project, such as a musical composition or album, a radio program, a video clip, a full-length movie or animation, an episode of a drama or television series, an interactive videogame, an application or any other type of audiovisual work or content. As such, user device 110 may receive media content 151 from retailer 150 using any type of wired or wireless technology after electronically purchasing media content 151 from retailer 150.

Also illustrated in FIG. 1, user device 110 transmits receipt 111 to redemption server 130. Receipt 111 may include a receipt for a previously purchased media content by user device 110 from a retailer. For example, receipt 111 may include a receipt for media content 151 purchased by user device 110 from retailer 150. As such receipt 111 may include the identity of media content 151 and the identity of user device 110. User device 110 may transmit receipt 111 to redemption server 130 using any wired or wireless technology.

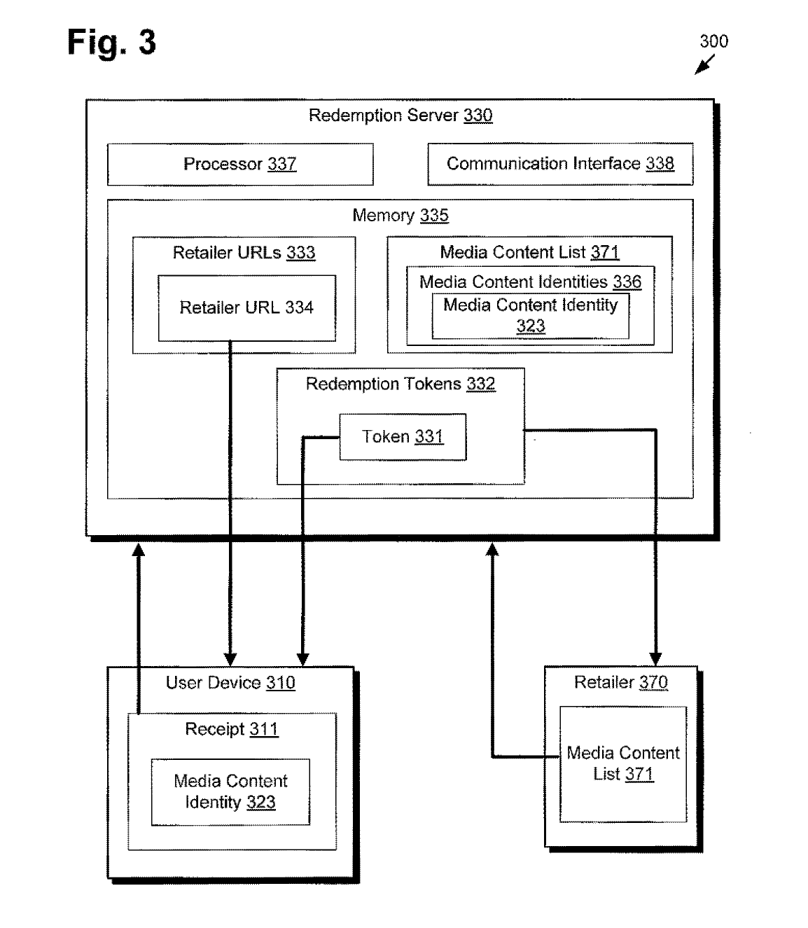

Also shown in FIG. 1, after receiving receipt 111 from user device 110, redemption server 130 uses receipt 111 to select token 131 and transmits token 131 to user device 110, as will be explained in greater detail with reference to FIG. 3. Token 131 may include a redemption code used by a user device 110 to redeem a previously purchased media content from a first retailer with a second retailer. For example, and using the example above where user device 110 purchased media content 151 from retailer 150, token 131 may be used by user device 110 to redeem media content 151 from retailer 170. Redemption server 130 may transmit token 131 to user device 110 using any wired or wireless technology.

It should be noted that in one implementation, a token may only be used by the user device that received the token to redeem the specific media content from a specific retailer. For example, and using the example above where user device 110 is trying to redeem media content 151 from retailer 170, token 131 may only be used by user device 110 to redeem media content 151 from retailer 170. In such an example, other user devices would not be able to redeem media content 151 from retailer 170 using token 131. Furthermore, user device 110 would not be able to use token 131 to redeem media content 151 from any other retailers other than retailer 170. As such, redemption server 130 only transmits token 131 to a single user device 110.

User device 110 transmits token 131 to retailer 170, and retailer 170 transmits media content 151 to user device 110. As discussed above, token 131 may include a redemption code that is used by user device 110 to redeem media content 151 from retailer 170. As such, user device 110 transmits token 131 to retailer 170, and retailer 170 transmits media content 151 to user device 110 in response to retailer 170 receiving token 131 from user device 110. User device 110 may transmit token 131 to retailer 170 and receive media content 151 from retailer 170 using any wired or wireless technology.

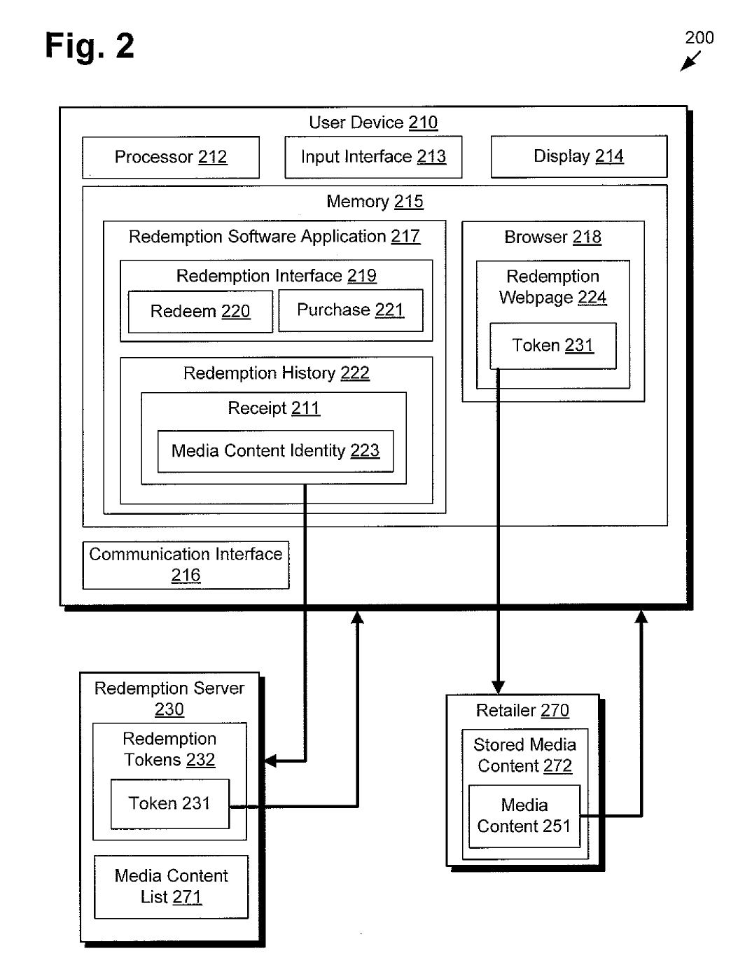

It should be noted that in one implementation, as will be illustrated and discussed in more detail with regard to FIGS. 2 and 3, user device 110 transmits token 131 to retailer 170 after logging into a user account using a redemption webpage provided by retailer 170. For example, redemption server 130 may transmit a universal resource locator (URL) for a redemption webpage provided by retailer 170 to user device 110 along with token 131. In such an example, a browser on user device 110 may automatically access the redemption webpage when a user of user device 110 clicks on the URL. For another example, token 131 may already be appended with the URL for the redemption webpage provided by retailer 170. In such an example, clicking a redeem button will cause the browser on user device 110 to receive token 131 and automatically access the redemption webpage, as will be explained in greater detail below. In either example, the user may then have to log into a user account for the redemption webpage using a username and password. After logging into the user account, user device 110 may automatically enter token 131 into the redemption webpage and transmit token 131 to retailer 170 using the redemption webpage.

Redemption server 130 transmits redemption tokens 132 to retailer 170. Redemption tokens 132 may include a list of each token that redemption server 130 has transmitted to user devices. For example, and as discussed above, redemption server 130 transmits token 131 to user device 110 so that user device 110 can use token 131 to redeem media content 151 from retailer 170. In such an example, redemption server 130 would further transmit token 131 to retailer 170 as part of redemption tokens 132 so that retailer 170 knows that token 131 is valid when user device 110 transmits token 131 to retailer 170. Retailer 170 would further use redemption tokens 132 to determine which media content to transmit to user devices when retailer 170 receives a token 131 from a user device 110.

Although FIG. 1 illustrates redemption server 130 transmitting redemption tokens 132 to retailer 170, the present disclosure is not limited to the implementation of FIG. 1. In one implementation, retailer 170 may transmit redemption tokens 132 to redemption server 130, where each token in redemption tokens 132 is associated with a specific media content. In such an implementation, redemption server 130 would transmit one of redemption tokens 132 to a user device 110 so that the user device 110 could redeem a media content using the redemption token. Redemption server 130 would thus not have to transmit redemption tokens 132 to retailer 170 as retailer 170 would already include redemption tokens 132.

Retailer 170 transmits media content list 171 to redemption server 130. Media content list 171 may include a list of every media content that can be redeemed or purchased from retailer 170. Redemption server 130 thus uses media content list 171 when determining if a media content from a receipt received from a user device 110 is available to be redeemed from retailer 170. If the media content is listed in media content list 171, redemption server 130 will transmit a token for the media content to the user device 110. For example, redemption server 130 would use media content list 171 to determine if media content 151 listed in receipt 111 is available to be redeemed by user device 110 from retailer 170. Redemption server 130 would then determine media content 151 is listed in media content list 171 and transmit token 131 to user device 110 so that user device 110 can redeem media content 151 from retailer 170.

In the implementation of FIG. 1, user device 110 has previously purchased media content 151 from retailer 150. After purchasing media content 151 from retailer 150, a user of user device 110 may wish to redeem media content 151 from retailer 170. User device 110 thus transmits receipt 111 for media content 151 to redemption server 130. Redemption server 130 then determines media content 151 is available for redemption from retailer 170 using media content list 171 and transmits token 131 to user device 110. Next, user device 110 transmits token 131 to retailer 170, and retailer 170 transmits media content 151 to user device 110 in response to retailer 170 receiving token 131 from user device 110.

It should be noted that the implementation of FIG. 1 only illustrates user device 110 redeeming a single media content from retailer 170, however, the present disclosure is not limited to user device 110 receiving only a single media content from retailer 170. In one implementation, user device 110 may transmit receipt 111 to redemption server 130 where receipt 111 includes a purchase history for more than one media content. In such an implementation, redemption server 130 would transmit a token 131 to user device 110 for each media content listed in receipt 111. User device 110 would then use the tokens to redeem each of the media contents from retailer 170.

FIG. 2 presents a user device used in digital purchase transfers between separate retailers, according to one implementation of the present disclosure. System 200 of FIG. 2 includes user device 210, redemption server 230, and retailer 270. User device 210 includes processor 212, input interface 213, display 214, memory 215, and communication interface 216. Memory 215 includes redemption software application 217 and browser 218. Redemption software application 217 includes redemption interface 219 and redemption history 222. Redemption interface 219 includes redeem 220 and purchase 221. Redemption history 222 includes receipt 211, which includes media content identity 223. Browser 218 includes redemption webpage 224, which includes token 231. Redemption server 230 includes redemption tokens 232 and media content list 271. Redemption tokens 232 includes token 231. Retailer 270 includes stored media content 272, which includes media content 251.

With reference to FIG. 2, user device 210, receipt 211, redemption server 230, token 231, redemption tokens 232, media content 251. retailer 270, and media content list 271 of FIG. 2 correspond respectively to user device 110, receipt 111, redemption server 130, token 131, redemption tokens 132, media content 151, retailer 170, and media content list 171 from FIG. 1. Furthermore, retailer 150 from FIG. 1 has been left out of FIG. 2 for clarity purposes.

User device 210 includes processor 212 and memory 215. Processor 212 may be configured to access memory 215 to store received input or to execute commands, processes, or programs stored in memory 215, such as redemption software application 217. Processor 212 may correspond to a processing device, such as a microprocessor or similar hardware processing device, or a plurality of hardware devices. However, in other implementations, processor 212 refers to a general processor capable of performing the functions required of user device 210. Memory 215 is capable of storing commands, processes, and programs for execution by processor 212. Memory 215 may be instituted as ROM, RAM, flash memory, or any sufficient memory capable of storing a set of commands. In other implementations, memory 215 may correspond to a plurality memory types or modules.

Also illustrated in FIG. 2, user device 210 includes input interface 213 and display 214. Input interface 213 may comprise, for example, a keyboard, a mouse, a game controller, a touch-screen input, a thermal and/or electrical sensor, or any other device capable of accepting user input for use with user device 210. Display 214 may comprise a liquid crystal display (LCD) screen built into user device 210. In alternative implementations of the present disclosure, display 214 may be another type of display hardware, such as cathode-ray tubes (CRT) monitors. In yet other implementations, display 214 may also be touch sensitive and may serve as input interface 213. Moreover, input interface 213 and display 214 may be externally attached to user device 210 through physical or wireless connection.

User device 210 further includes communication interface 216. Communication interface 216 includes any device that is capable of both transmitting data with a transmitter and receiving data with a receiver. Processor 212 of user device 210 is thus configured to control communication interface 216 to communicate with other electronic devices, such as redemption server 230 and retailers. As such, communication interface 216 can utilize, for example, one or more of Wireless Fidelity (Wi-Fi), Worldwide Interoperability for Microwave Access (WiMax), ZigBee, Bluetooth, Bluetooth low energy, Code Division Multiple Access (CDMA), Evolution-Data Optimized (EV-DO), Global System for Mobile Communications (GSM), Long Term Evolution (LTE), and other types of wired and wireless technology.

User device 210 includes redemption software application 217, and utilizes redemption software application 217 to both purchase media content from retailers, and to redeem already purchased media content from retailers. For example, user device 210 may utilize redemption software application 217 to either purchase media content 251 from retailer 270 if user device 210 has not already purchased media content 251 from a retailer, or user device 210 may utilize redemption software application 217 to redeem media content 251 from retailer 270 if user device 210 has already purchased media content 251 from a retailer.

Redemption software application 217 includes redemption interface 219, which includes redeem 220 and purchase 221. Redemption interface 219 can be utilized by a user of user device 210 to search through media content that is available from retailers. The user of user device 210 can then use redemption interface 219 to either buy media content that has not already been purchased using purchase 221, or redeem media content from a retailer using redeem 220 if the user has already purchased the media content from a retailer, where redeem 220 and purchase 221 correspond to interactive buttons on redemption interface 219.

For example, a user of user device 210 may be using redemption interface 219 to search through media content that is available through retailer 270. When displaying media content on display 214 of user device 210, redemption interface 219 may display redeem 220 if the user of user device 210 has previously purchased the media content from a retailer, or redemption interface 219 may display purchase 221 if the user of user device 210 has not previously purchased the media content from a retailer. If the user presses redeem 220, redemption software application 217 will redeem the media content from retailer 170, as will be explained in greater detail below, and if the user presses purchase 221, redemption software application 217 will take the user to a webpage of retailer 170 so that the user can purchase the media content.

Redemption software application 217 includes redemption history 222. Redemption history 222 may include the purchase history of user device 210 for purchasing media content from retailers. As such, redemption history 222 includes receipt 211, which includes media content identity 223. As discussed above, receipt 211 may include a receipt for a previously purchased media content by user device 210 from a retailer. Media content identity 223 may thus include the identity of the media content that was purchased by user device 210 from the retailer.

User device 210 includes browser 218. User device 210 may utilize browser 218 when purchasing or redeeming media content from a retailer. For example, browser 218 may open redemption webpage 224, where redemption webpage 224 may include a webpage controlled by a retailer that user device 210 can access to buy media content from the retailer, or user device 210 can access to redeem media content from the retailer using a token. As such, redemption webpage 224 may be similar to interactive interface 219 except that redemption webpage 224 is accessed using browser 218. For example, redemption webpage 224 may include a webpage controlled by retailer 270 that user device 210 can access to either buy media content 251 from retailer 270, or user device 210 can access to redeem media content 251 from retailer 270 if a user of user device 210 has already purchased media content 251 from a retailer.

Retailer 270 includes stored media content 272. As discussed above, media content 251 may include a creative media work or project, such as a musical composition or album, a radio program, a video clip, a full-length movie or animation, an episode of a drama or television series, an interactive videogame, or any other type of audiovisual work or content. As such, stored media content 272 may include every media content that is available from retailer 270.

In the implementation of FIG. 2, a user of user device 210 may have used redemption software application 217 to redeem media content 251 by pressing redeem 220 on redemption interface 219. After pressing redeem 220, redemption software application 217 retrieves receipt 211 from redemption history 222 and transmits receipt 211 to redemption server 230 using communication interface 216. In response to receiving receipt 211 from user device 210, redemption server 230 compares media content identity 223 from receipt 211 with media content list 271 to see if media content 251 is available from retailer 270. Redemption server 230 then selects token 231 from redemption tokens 232, where token 231 is used by user device 210 to redeem media content 251 from retailer 270. Next, redemption server 230 transmits token 231 to user device 210.

After receiving token 231 from redemption server 230 using communication interface 216, user device 210 utilizes browser 218 to redeem media content 251 from retailer 270. First, user device 210 utilizes redemption software application 217 to open redemption webpage 224 using browser 218. As will be discussed in greater detail with regard to FIG. 3, redemption server 230 may have transmitted the URL for redemption webpage 224 along with token 231, or token 231 may have already been appended with with the URL, so that redemption software application 217 could open redemption webpage 224. User device 210 then uses redemption software application 217 to automatically enter token 231 into redemption webpage 224. Finally, redemption software application 217 transmits token 231 to retailer 270 using redemption webpage 224 and receives media content 251 from retailer 270. User device 210 may transmit token 231 to retailer 270 and receive media content 251 from retailer 270 using communication interface 216.

It should be noted that the implementation of FIG. 2 only illustrates using redemption webpage 224 to transmit token 231 to retailer 270, however, the present disclosure is not limited to the implementation of FIG. 2. For example, in one implementation, the URL transmitted from redemption server 230 may direct redemption interface 219 to access retailer 270 for transmitting token 231. In such an example, user device 210 would utilize the URL to access retailer 270 and transmit token 231 using redemption interface 219 to retailer 270. As such, and as discussed above, redemption interface 219 and redemption webpage 224 may be similar, except, redemption interface 219 accesses retailer 270 and transmits token 231 using redemption software application 217 while redemption webpage accesses retailer 270 and transmits token 231 using browser 218.

FIG. 3 presents a redemption server used in digital purchase transfers between separate retailers, according to one implementation of the present disclosure. System 300 of FIG. 3 includes user device 310, redemption server 330, and retailer 370. User device 310 includes receipt 311, which includes media content identity 323. Redemption server 330 includes processor 337, communication interface 338, and memory 335. Memory 335 includes redemption tokens 332, retailer URLs 333, and media content list 371. Redemption tokens 332 include token 331. Retailer URLs 333 includes retailer URL 334. Media content list 371 includes media content identities 336, which includes media content identity 323. Retailer 370 includes media content list 371.

With reference to FIG. 3, user device 310, receipt 311, redemption server 330, token 331, redemption tokens 332, retailer 370, and media content list 371 of FIG. 3 correspond respectively to user device 110, receipt 111, redemption server 130, token 131, redemption tokens 132, retailer 170, and media content list 171 from FIG. 1. Furthermore, user device 310, receipt 311, media content identity 323, redemption server 330, token 331, redemption tokens 332, retailer 370, and media content list 371 of FIG. 3 correspond respectively to user device 210, receipt 211, media content identity 223, redemption server 230, token 231, redemption tokens 232, retailer 270, and media content list 271 from FIG. 2.

Redemption server 330 includes processor 337 and memory 335. Processor 337 may be configured to access memory 335 to store received input or to execute commands, processes, or programs stored in memory 335. Processor 337 may correspond to a processing device, such as a microprocessor or similar hardware processing device, or a plurality of hardware devices. However, in other implementations, processor 337 refers to a general processor capable of performing the functions required of redemption server 330. Memory 335 is capable of storing commands, processes, and programs for execution by processor 337. Memory 335 may be instituted as ROM, RAM, flash memory, or any sufficient memory capable of storing a set of commands. In other implementations, memory 335 may correspond to a plurality memory types or modules.

Also illustrated in FIG. 3, redemption server 330 further includes communication interface 338. Communication interface 338 includes any device that is capable of both transmitting data with a transmitter and receiving data with a receiver. Processor 337 of redemption server 330 is thus configured to control communication interface 338 to communicate with other electronic devices, such as user device 310 and retailers. As such, communication interface 338 can utilize, for example, one or more of Wireless Fidelity (Wi-Fi), Worldwide Interoperability for Microwave Access (WiMax), ZigBee, Bluetooth, Bluetooth low energy, Code Division Multiple Access (CDMA), Evolution-Data Optimized (EV-DO), Global System for Mobile Communications (GSM), Long Term Evolution (LTE), and other types of wired and wireless technology.

Redemption server 330 includes retailer URLs 333. As discussed above, in one implementation, redemption server 330 transmits a URL for a redemption webpage of retailer 370 to user device 310, where the URL is used by user device 310 to access the redemption webpage provided by retailer 370 to redeem media content. As such, retailer URLs 333 includes the URLs for the redemption webpages of each retailer that uses redemption server 330. For example, retailer URL 334 of retailer URLs 333 may be used by user device 310 to access the redemption webpage of retailer 370, such as redemption webpage 224 of retailer 270 from FIG. 2.

It should be noted that the implementation of FIG. 3 illustrates redemption server 330 transmitting retailer URL 334 to user device 310 separate from token 331, however, as discussed above, the present disclosure is not limited to the implementation of FIG. 3. In one implementation, token 331 is appended with URL 334. In such an implementation, when a user of user device 310 click the “redeem” button, such as redeem 220 from FIG. 2, redemption server 330 transmits token 331 appended with URL 334 to user device 310, and user device 310 automatically accesses the redemption webpage of retailer 370.

In the implementation of FIG. 3, user device 310 transmits receipt 311 including media content identity 323 to redemption server 330. In response to receiving receipt 311 from user device 310, redemption server 330 compares media content identity 323 with media content list 371 to determine if media content identity 323 is included in media content list 371. If redemption server 330 determines media content identity 323 is included in media content list 371, as illustrated in FIG. 3, redemption server 330 transmits token 331 and retailer URL 334 user device 310. User device 310 may then redeem a media content associated with media content identity 323 from retailer 370 using token 331 and retailer URL 334.

Retailer 370 transmits media content list 371 to redemption server 330, where media content list 371 includes a list of all the media content available from retailer 370. Furthermore, redemption server 330 transmits redemption tokens 332 to retailer 370. As discussed above, redemption tokens 332 includes a list of the tokens that redemption server 330 has transmitted to user devices to redeem media content.

Although redemption server 330 is shown as transmitting redemption tokens 332 to retailer 370, the present disclosure is not limited to the implementation of FIG. 3. For example, in one implementation, as discussed above, retailer 370 may transmit redemption tokens 332 along with media content list 371 to redemption server 330 so that redemption server 330 can transmit tokens from redemption tokens 332 to user devices. In such an implementation, redemption server 330 would not transmit redemption tokens 332 to retailer 370 as retailer 370 would already include redemption tokens 332.

It should be noted that in one implementation, token 331 may only be associated with user device 310. For example, after redemption server 330 transmits token 331 to user device 310, redemption server 330 will not transfer the same token 331 to any other user devices trying to redeem the media content associated with media content identity 323. In such an example, user device 310 may request token 331 from redemption server 330 multiple times if user device 310 loses token 331 and has not already used token 331 to redeem the media content that is associated with media content identity 323.

It should further be noted that redemption server 330 may expire token 331. For example, in one implementation, redemption server 330 will expire token 331 after a predetermined time has passed after redemption server 330 transmitted token 331 to user device 310 if user device 310 does not use token 331 to redeem the media content. For another example, in a second implementation, redemption server 330 will expire token 331 when user device 310 uses token 331 to redeem the media content from retailer 370. In each implementation, redemption server 330 may store a database of the expired tokens so that redemption server 330 does not transmit an expired token to another user device.

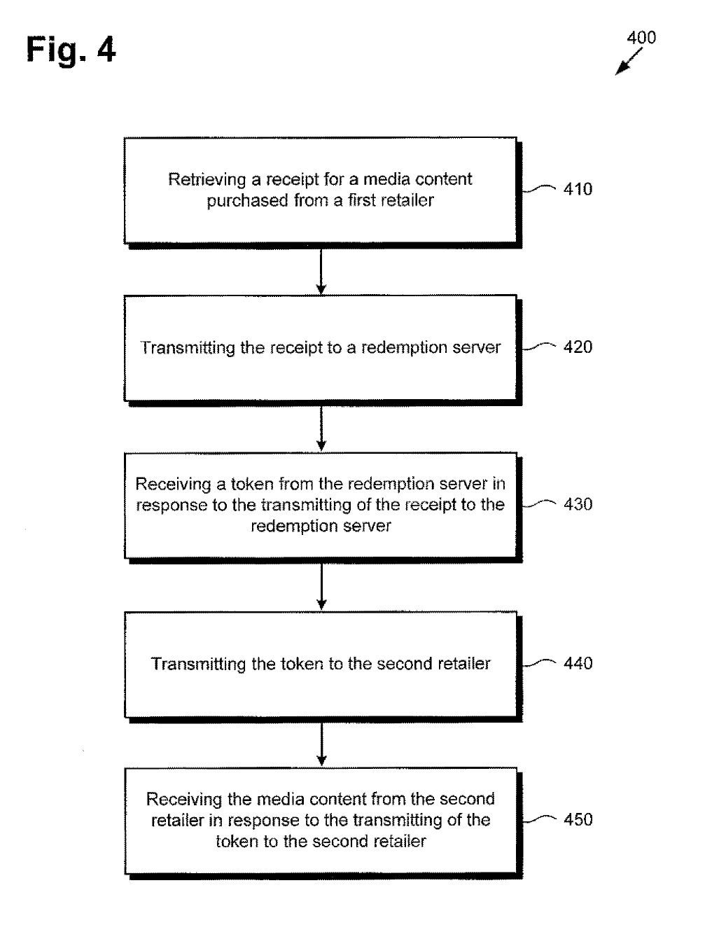

FIG. 4 shows a flowchart illustrating a method for a user device performing digital purchase transfers between separate retailers, according to one implementation of the present disclosure. The approach and technique indicated by flowchart 400 are sufficient to describe at least one implementation of the present disclosure, however, other implementations of the disclosure may utilize approaches and techniques different from those shown in flowchart 400. Furthermore, while flowchart 400 is described with respect to FIG. 2, the disclosed inventive concepts are not intended to be Limited by specific features shown and described with respect to FIG. 2. Furthermore, with respect to the method illustrated in FIG. 4, it is noted that certain details and features have been left out of flowchart 400 in order not to obscure the discussion of inventive features in the present application.

Referring now to flowchart 400 of FIG. 4, flowchart 400 includes retrieving a receipt for a media content purchased from a first retailer (410). For example, processor 212 of user device 210 may execute redemption software application 217 to retrieve receipt 211 from memory 215. As discussed above, receipt 211 may include a media content purchased by user device 210 from a first retailer, such as user device 110 purchasing media content 151 from retailer 150 of FIG. 1.

Flowchart 400 also includes transmitting the receipt to a redemption server (420) and receiving a token from the redemption server in response to the transmitting of the receipt to the redemption server (430). For example, processor 212 of user device 210 may execute redemption software application 217 to transmit receipt 211 to redemption server 230 and receive token 231 from redemption server 230 in response to transmitting receipt 211 to redemption server 230. As discussed above, token 231 is used by user device 210 to redeem media content 251 from retailer 270.

Flowchart 400 also includes transmitting the token to the second retailer (440) and receiving the media content from the second retailer in response to the transmitting of the token to the second retailer (450). For example, processor 212 of user device 210 may execute redemption software application 217 to transmit token 231 to retailer 270 and receive media content 251 from retailer 270 in response to transmitting token 231 to retailer 270.

As discussed above and as illustrated in FIG. 3, processor 212 of user device 210 may further execute redemption software application 217 to receive a retailer URL from redemption server 230 with token 231. In such an implementation, processor 212 of user device 210 may execute redemption software application 217 to access redemption webpage 224 using the retailer URL and automatically populate redemption webpage 224 with token 231 after a user of user device 210 logs into his or her account with retailer 270 using redemption webpage 224. Finally, processor 212 of user device 210 may further execute redemption software application 217 to transmit token 231 to retailer 270 using redemption webpage 224 and receive media content 251 from retailer 270 using redemption webpage 224.

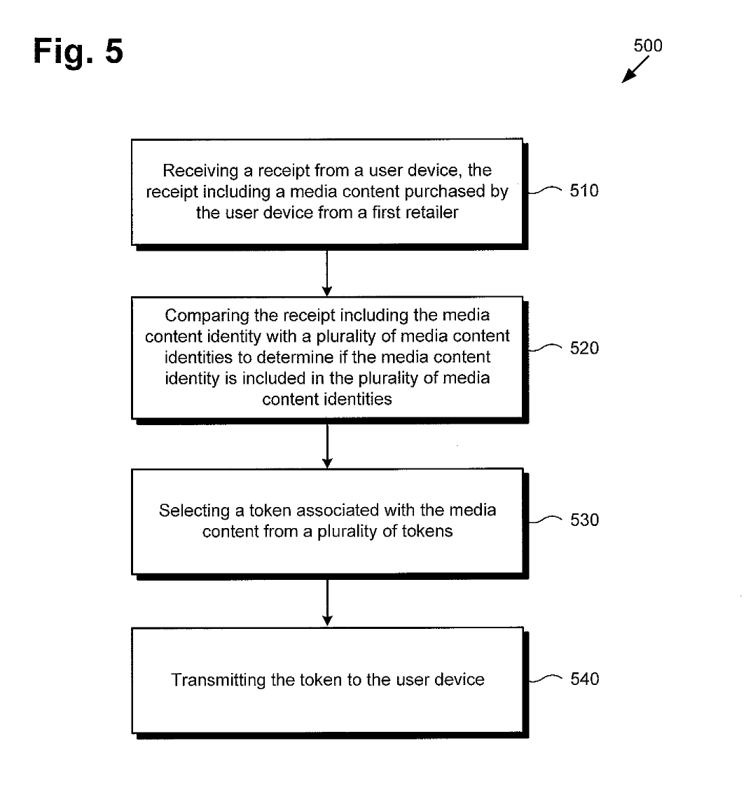

FIG. 5 shows a flowchart illustrating a method for a redemption server performing digital purchase transfers between separate retailers, according to one implementation of the present disclosure. The approach and technique indicated by flowchart 500 are sufficient to describe at least one implementation of the present disclosure, however, other implementations of the disclosure may utilize approaches and techniques different from those shown in flowchart 500. Furthermore, while flowchart 500 is described with respect to FIG. 3, the disclosed inventive concepts are not intended to be limited by specific features shown and described with respect to FIG. 3. Furthermore, with respect to the method illustrated in FIG. 5, it is noted that certain details and features have been left out of flowchart 500 in order not to obscure the discussion of inventive features in the present application.

Referring now to flowchart 500 of FIG. 5, flowchart 500 includes receiving a receipt from a user device, the receipt including a media content purchased by the user device from a first retailer (510). For example, processor 337 of redemption server 330 may receive receipt 311 from user device 310, where receipt 311 includes media content identity 323. Media content identity 323 may include the identity of a media content purchased by user device 310 from a first retailer, such as user device 110 purchasing media content 151 from retailer 150 of FIG. 1.

Flowchart 500 also includes comparing the receipt including the media content identity with a plurality of media content identities to determine if the media content identity is included in the plurality of media content identities (520). For example, processor 337 of redemption server 330 may compare receipt 311 including media content identity 323 with media content list 371 to determine if media content identity 323 is included in media content list 371. As discussed above, media content list 371 includes a list of all of the identities for media contents that are available from retailer 370.

Flowchart 500 also includes selecting a token associated with the media content from a plurality of tokens (530) and transmitting the token to the user device (540). For example, processor 337 of redemption server 330 may select token 331 from redemption tokens 332, where token 331 is associated with the media content that corresponds to media content identity 323. Processor 337 of redemption server 330 may then transmit token 331 to user device 310.

From the above description it is manifest that various techniques can be used for implementing the concepts described in the present application without departing from the scope of those concepts. Moreover, while the concepts have been described with specific reference to certain implementations, a person of ordinary skill in the art would recognize that changes can be made in form and detail without departing from the scope of those concepts. As such, the described implementations are to be considered in all respects as illustrative and not restrictive. It should also be understood that the present application is not limited to the particular implementations described above, but many rearrangements, modifications, and substitutions are possible without departing from the scope of the present disclosure.

What is claimed is:

1. A user device comprising:
a memory storing a receipt for a media content purchased from a first retailer; and
a processor configured to:
retrieve the receipt for the media content from the memory;
transmit the receipt to a redemption server;
receive a token from the redemption server in response to the transmitting of the receipt to the redemption server;
transmit the token to a second retailer; and
receive the media content from the second retailer in response to the transmitting of the token to the second retailer.

2. The user device of claim 1, wherein before the transmitting of the token to the second retailer, the processor is further configured to:
receive a universal resource locator (URL) from the redemption server;
access a redemption interface of the second retailer using the URL, the redemption interface being for use to redeem the media content from the second retailer; and
automatically populate the redemption interface with the token.

3. The user device of claim 2, wherein before automatically populating the redemption interface with the token, the processor is further configured to log into a user account associated with the second retailer using the redemption interface.

4. The user device of claim 1, wherein before the retrieving of the receipt for the media content, the processor is further configured to receive a request to redeem the media content.

5. The user device of claim 1, wherein redemption server compares a media content identity from the receipt with a plurality of media content identities provided by the second retailer to select the token.

6. The user device of claim 1, wherein the token is associated with the user device that purchased the media content from the first retailer.

7. The user device of claim 1, wherein the media content includes at least one of a movie, music, app and a video game.

8. A server comprising:
a memory storing a plurality of media content identities and a plurality of tokens, each of the plurality of tokens used to redeem one of a plurality of media contents from a second retailer, each of the plurality of media contents associated with one of the plurality of media content identities; and
a processor configured to:
receive a receipt from a user device, the receipt including a media content identity associated with a media content purchased by the user device from a first retailer;
compare the receipt including the media content identity with the plurality of content identities to determine that the media content identity is included in the plurality of identities;
select a token from the plurality of tokens, the token used to redeem the media content associated with the media content identity from the second retailer; and
transmit the token to the user device.

9. The server of claim 8, wherein the processor is further configured to transmit a universal resource locator (URL) for a redemption interface of the second retailer to the user device.

10. The server of claim 9, wherein the user device accesses the redemption interface using the URL, and wherein the redemption interface is automatically populated with the token.

11. The server of claim 8, wherein the token expires after the user device uses the token to redeem the media content from the second retailer.

12. The server of claim 8, wherein the user device uses the token to redeem the media content from the second retailer.

13. The server of claim 8, wherein the media content includes at least one of a movie, music, and a video game.

14. A method for redeeming a media content from a second retailer, the method comprising:
retrieving a receipt for the media content purchased from a first retailer;
transmitting the receipt to a redemption server;
receiving a token from the redemption server in response to the transmitting of the receipt to the redemption server;
transmitting the token to the second retailer; and
receiving the media content from the second retailer in response to the transmitting of the token to the second retailer.

15. The method of claim 14, wherein before the transmitting of the token to the second retailer, the method further comprises:
receiving a universal resource locator (URL) from the redemption server;
accessing a redemption interface of the second retailer using the URL, the redemption interface being for use to redeem the media content from the second retailer; and
automatically populating the redemption interface with the token.

16. The method of claim 15, wherein before the automatically populating the redemption interface with the token, the method further comprises logging into a user account associated with the second retailer using the redemption interface.

17. The method of claim 14, wherein before the retrieving of the receipt for the media content, the method further comprises receiving a request to redeem the media content.

18. The method of claim 14, wherein redemption server compares a media content identity from the receipt with a plurality of media content identities provided by the second retailer to select the token.

19. The method of claim 14, wherein the token is associated with the user device that purchased the media content from the first retailer.

20. The method of claim 14, wherein the media content includes at least one of a movie, music, and a video game.
